(19) United States
(12) Patent Application Publication
(10) Pub. No.: US 2010/0099359 A1
(43) Pub. Date: Apr. 22, 2010

(54) METHOD FOR RECEIVING DATA SERVICE

(75) Inventors: Byoungwook Lee, Seoul (KR); Seunghyup Ryoo, Seoul (KR); Kichon Kang, Seoul (KR); Jaejoon Park, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/528,577

(22) PCT Filed: Feb. 26, 2008
(86) PCT No.: PCT/KR08/01114

§ 371 Date: Sep. 17, 2009

(30) Foreign Application Priority Data
Feb. 26, 2007 (KR) 10-2007-0018890

(51) Int. Cl. H04B 7/005

(52) U.S. Cl. 455/41.3

(57) ABSTRACT

A method for receiving a data service is disclosed. A method for handoff in content transmission comprises the steps of: receiving status information of a data service via short-distance wireless communication from a first device receiving a data service of a specific content through a server; transmitting the status information of the data service to the server; and continuing the reception of the data service being transmitted to the first device from the server. Accordingly, there is an effect of convenience because another apparatus continuously services a corresponding data service during the reception of a specific data service using a specific device.

### TECHNICAL FIELD

The present invention relates to a method for receiving a data service.

### BACKGROUND ART

With the development of internet services and the advent of mobile devices, video and music streaming services have become easily available whenever and wherever needed.

Users wish to continue receiving the video and music streaming services, which have been received by one apparatus, by another apparatus. For instance, a user who has to go out in the middle of watching a specific drama on TV by a streaming service may wish continue watching the same drama through a mobile device.

Conventionally, in this case, the user has to finish the streaming service on the TV, and then access the corresponding streaming server again by using a mobile device. At this time, there is a problem of inconvenience that the user has to find a previous viewed content and move back to a previously viewed portion of the content.

### DISCLOSURE OF INVENTION

### Technical Problem

In order to solve this conventional problem, it is an object of the present invention to provide a method for handoff in content transmission of a device comprising a short-distance wireless communication module for continuing the provision of a corresponding data service in another apparatus during the reception of a specific data service using a specific device.

### Technical Solution

The method for handoff in content transmission of the present invention comprises the steps of: receiving status information of a data service via short-distance wireless communication from a first device receiving a data service of a specific content through a server; transmitting the status information of the data service to the server; and continuing the reception of the data service being transmitted to the first device from the server.

If the specific content is video or music, the data service may be a streaming service.

Otherwise, if the specific content is a web browser, the data service may be a web service.

Additionally, the method may further comprise the step of detecting a location of the first device via short-distance wireless communication.

Here, the status information of the data service may include the location of the server, the name of the specific content, authentication information, and a playback position of the specific content.

Additionally, the short-distance wireless communication may be any one of NFC (Near Field Communication), Bluetooth, ZigBee, Wireless LAN, and Wibro.

### Advantageous Effects

According to the present invention, there is an effect of convenience because another apparatus continuously services a corresponding data service during the reception of a specific data service using a specific device.

### BRIEF DESCRIPTION OF THE DRAWINGS

FIG. 1 is a block diagram showing the configuration of a device according to one embodiment of the present invention.

FIG. 2 is a configuration diagram of a content transmission system according to one embodiment of the present invention.

FIG. 3 is a flow chart sequentially showing a method for handoff in content transmission using short-distance wireless communication according to one embodiment of the present invention.

FIGS. 4 and 5 are illustrations for explaining a screen displaying a playing video in first and second devices according to one embodiment of the present invention.

FIG. 6 is a flow chart sequentially showing one example of delivering status information of a content from the second device to a third device according to one embodiment of the present invention.

FIG. 7 is an illustration for explaining the occurrence of a handoff during the reception of a web service according to one embodiment of the present invention.

### BEST MODE FOR CARRYING OUT THE INVENTION

A method for handoff in content transmission of the present invention comprises the steps of: receiving status information of a data service via short-distance wireless communication from a first device receiving a data service of a specific content through a server; transmitting the status information of the data service; and continuing the reception of the data service being transmitted to the first device from the server.

### Mode for the Invention

A method for handoff in content transmission using short-distance wireless communication according to one embodiment of the present invention will be described in detail with reference to the accompanying drawings.

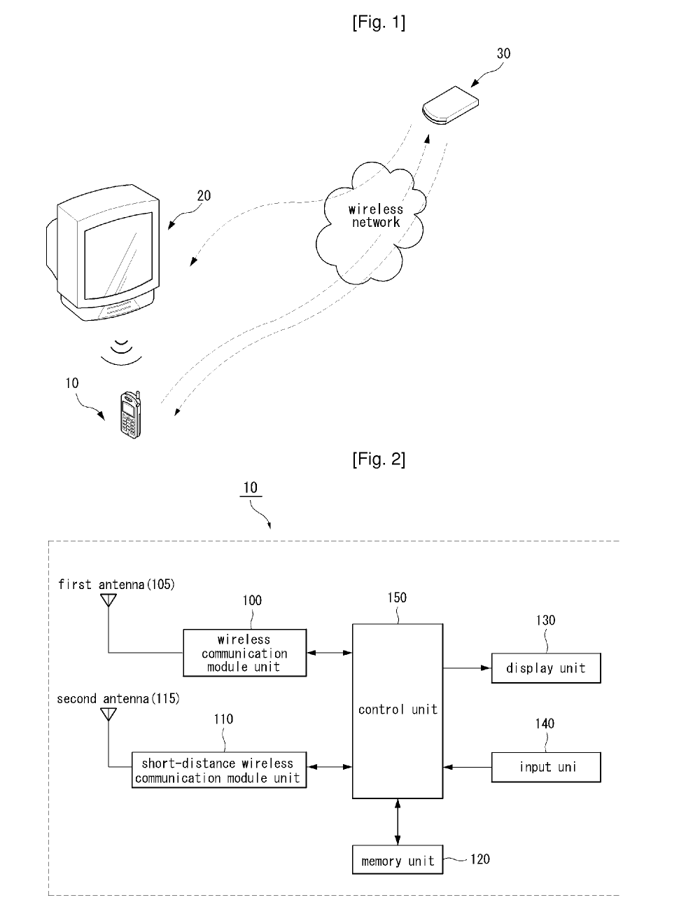

FIG. 1 is a block diagram showing the configuration of a device according to one embodiment of the present invention.

As shown in FIG. 1, the device according to one embodiment of the present invention may be a mobile terminal 10, which comprises a wireless communication module unit 100, a short-distance wireless communication module unit 110, a memory unit 120, a display unit 130, an input unit 140, and a control unit 150.

The wireless communication module unit 100 transmits status information of a data service of a specific content to a server by performing communication with a base station through a first antenna 105, and continues receiving the data service being transmitted to a first device from the server.

The short-distance wireless communication module unit 110 may be an NFC (Near Field Communication) module, and receives status information of a data service through a second antenna 115 from the first device receiving the data service of a specific content through the server.

The memory unit 120 may be comprised of a flash memory, a RAM, an EEPROM (electrically erasable programmable read only memory), etc., and stores a predetermined program for controlling the overall operation of the mobile terminal 10. In addition, the memory unit 120 stores a specific content received through the data service from the wireless communication module 100, or stores status information of the data service of the specific content received from the short-distance wireless communication module 110.

At this time, the status information of the data service includes the location of the server, the name of the specific content, authentication information, and position information of the data service received up to a specific point of time by the first device among the entire data services of the specific content provided from the server.

The display unit 130 displays the specific content stored in the memory unit or the content being provided in real time from the server.

The input unit 140 has a numeric key and various function keys to output a signal corresponding to a key selected by a user to the control unit 150.

The control unit 150 has an MSM (Mobile Station Modem) to control general input and output of the mobile terminal 10. At this time, the control unit 150 controls such that the status information of the data service stored in the memory unit 120 can be transmitted to the server through the wireless communication module unit 100.

The operation of the present invention thus configured will be discussed below.

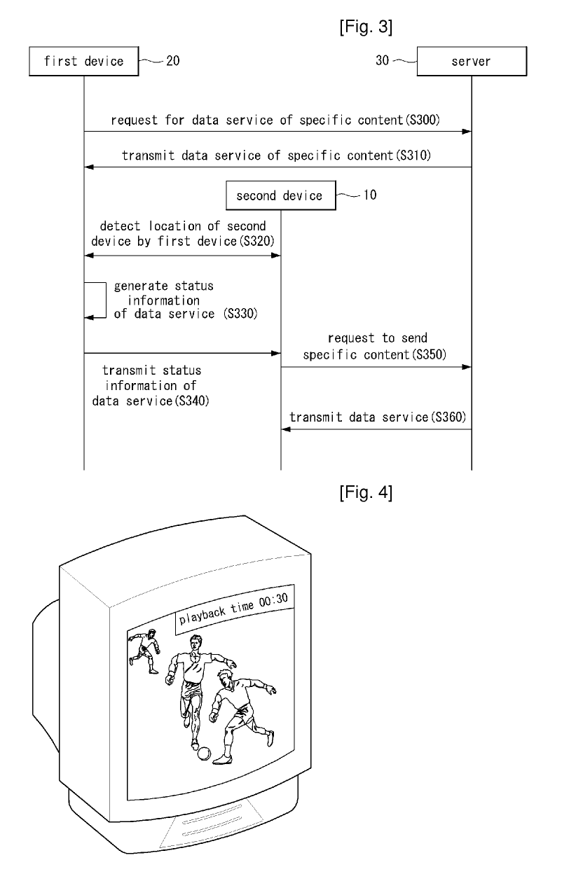

FIG. 2 is a configuration diagram of a content transmission system according to one embodiment of the present invention. FIG. 3 is a flow chart sequentially showing a method for handoff in content transmission using short-distance wireless communication according to one embodiment of the present invention.

Referring to FIGS. 2 and 3, the method for handoff in content transmission using short-distance wireless communication according to one embodiment of the present invention comprises the step S300-S330 of receiving status information of a data service via short-distance wireless communication from a first device 20 receiving a data service of a specific content through a server 30, the step S330-S340 of transmitting the status information of the data service to the server 30, and the step S360 of continuing the reception of the data service being transmitted to the first device 20 from the server 30.

First, the content transmission system comprises a first device 20, a second device 10, and a content server 30. The first device 10 and the second device 10 incorporate an NFC (Near Field Communication) module for enabling short-distance wireless communication.

First, a television, which is the first device 20, accesses to a ‘UCC (User Created Contents) site of LG’, which is the content server 30, and requests for the transmission of the ‘video content of the soccer match on 7 Feb. 2007’ in S300.

Therefore, the content server 30 provides the ‘video content of the soccer match on 7 Feb. 2007’ requested by the television serving as the first device 20 in the form of a streaming service S310.

Here, the streaming service refers to a service that is played and run in real time without downloading by accessing the content server 30, unlike a service that is run after directly downloading and storing a content. Accordingly, the playback time of contents is reduced, and there is little effect on the memory capacity of the device that receives a streaming service.

At this time, it is necessary for the first device 20, i.e., the client receiving contents, to collect contents and successively send the contents to an application program for converting the contents into sound or pictures. If the speed at which the first device 20 serving as the client receives is too fast, excessive contents are stored in a buffer and streamed simultaneously.

In this way, a mobile device serving as the second device 10 approaches, within a specific distance, the first device 20 which is receiving the streaming service of video contents from the content server 30, thereby detecting each other's location in S320.

The first device 20 and second device 10 incorporating an NFC module is capable of communication by performing short-distance wireless communication with a low electric power in any direction within a distance of 10 CM by using a frequency of 13.56 MHZ.

At this time, the NFC technology is developed from the radio frequency identification (hereinafter, ‘RFID’) technology, and the international standards for existing 13.56 MHZ RFID technologies include IS014443 A/B, ISO 15693 and so on. This NFC technology includes all these RFID technologies. The RFID technology defines a communication protocol between readers and tags, while the NFC technology enables data communication between readers.

In other words, two-way data communication is possible between the devices incorporating an NFC module. Therefore, the first device 20 and the second device 10 start communication by detecting each other's location according to the procedure of a standard document related to the above-described NFC, and a description thereof will be omitted.

In this way, a mobile device serving as the second device 10 approaches the first device 20 within a specific distance, thereby detecting each other's location in S320.

Afterwards, once the first device 20 and the second device 10 are ready to send and receive specific data according to the NFC standard, the first device 20 generates status information about a video content being received from the content server 30 in S330.

Here, the status information includes the location of the content server 30, the name of a video content, authentication information, and the playback position of the video content being run at the point of time when the location of the second device 10 is detected.

For example, the location of the content server 30 may be ‘ucc.1g.com/soccer’, and the name of the video content may be ‘parkjisung0207’. The authentication information may be ‘bwlee1247’, and the playback position of the video content may be ‘30’. Here, the authentication information may be a key value received from the content server 30 upon requesting the content server 30 to send the video through the first device 20.

In addition, the playback position ‘30’ indicates that the ‘video content of the soccer match on 7 Feb. 2007’ being played at the point of time when the first device 20 detects the location of the second device 10 has a playback time of 30 minutes.

The status information about the video content is transmitted from the first device 20 to the second device 10 in S340. The second device 10 having received the status information transmits the status information to the corresponding content server 30 in S350.

Therefore, the corresponding content server 30 continuously services the second device 10 with the video content that has been in service to the first device 20 according to the status information about the video content received from the second device 10 in S360.

That is to say, since the playback position is ‘30’ according to the status information about the video content received from the second device 10, the content server 30 continuously services the second device 10 with the video of the part subsequent to the playback time of 30 minutes of the corresponding video.

FIGS. 4 and 5 are illustrations for explaining a screen displaying a playing video in first and second devices according to one embodiment of the present invention.

As shown in FIG. 4, according to one embodiment of the present invention, a video content with 30 minutes elapsed since the start of playing is being run in the first device 20.

In this state, when the second device 10 is in proximity to the first device 20, as shown in FIG. 5, the video content being played in the first device 20 is continuously played in the second device 10 according to the aforementioned procedure.

At this time, the video content to be played in the second device 10 can be received and played, starting from the part subsequent to the elapse of 31 minutes since the start of playing.

Meanwhile, the second device 10 according to one embodiment of the present invention may receive the status information about a video content from the first device 20 and forward it to another device, and one example thereof is as follows.

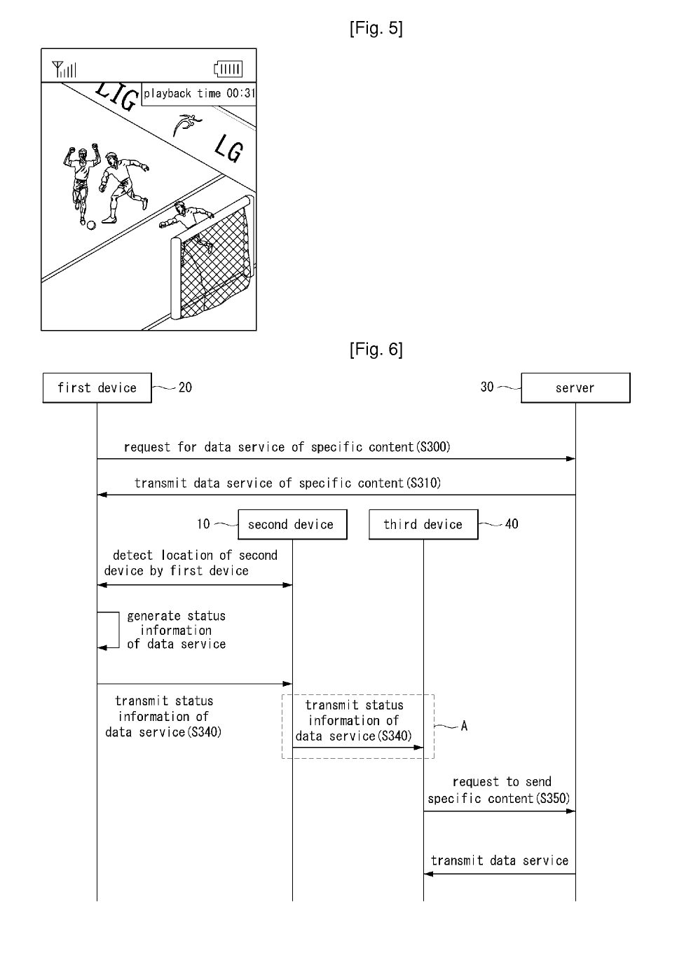

FIG. 6 is a flow chart sequentially showing one example of delivering status information of a content from the second device to a third device according to one embodiment of the present invention.

As shown in FIG. 6, the second device 10 may receive the status information about a video content from the first device 2, and then forward it to a third device 40.

Consequently, the third device 40 transmits the status information about the video content received from the second device 10 to the corresponding content server 30. Afterwards, the third device 40 can be serviced with the video content that has been in service to the first device 20 according to the procedure described in FIGS. 4 and 5.

As above, if the second device 10 does not support the running of the corresponding content, the content may not be run but forwarded to the third device 40 located in proximity.

This content may be a web browser, and one example thereof is as follows.

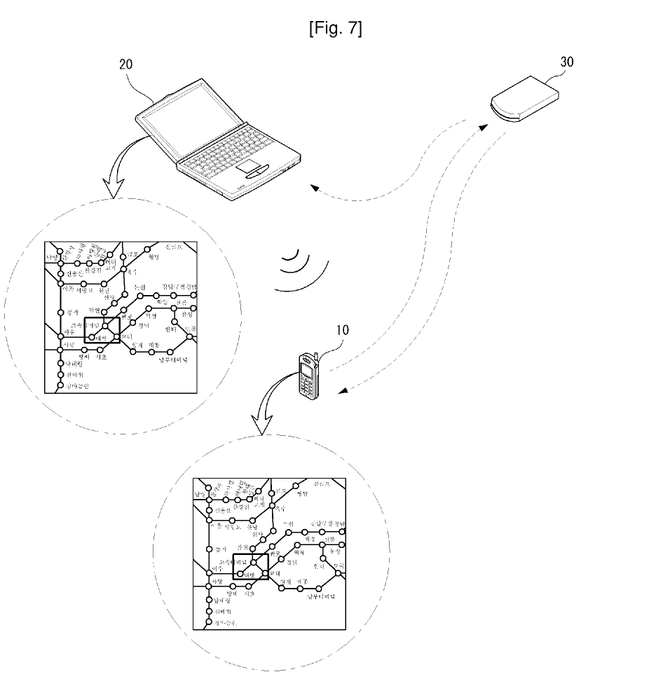

FIG. 7 is an illustration for explaining the occurrence of a handoff during the reception of a web service according to one embodiment of the present invention.

As shown in FIG. 7, according to one embodiment of the present invention, a notebook computer serving as the first device 20 is receiving a ‘Seoul Metropolitan Subway Map Service’ through a web server serving as the content server 30.

At this time, a mobile terminal 10 serving as the second device 10 can be continuously serviced with the web browser that has been in service to the first device 20 by receiving status information of the web browser from the first device 20 through NFC communication according to the above-described procedure and transmits it to the content server 30.

While the embodiments described so far have been described with respect to NFC, which is short-distance wireless communication, the present invention is not limited thereto but it is possible to use wireless communications, such as Bluetooth, Zigbee, Wireless LAN, and Wibro.

In addition, while the embodiments described so far have been described with respect to a case where, if a content is a video, the playback position included in the status information is a time period during which the corresponding video is played, the present invention is not limited thereto. For example, if a content is a video, it is possible to include the number of the frame in which the corresponding video is played, and every other information notifying of the position at which the video is played is available.

Further, a specific content may be various contents such as music, as well as video.

Further, authentication information may be the ID (Identity) of a user who has accessed the corresponding content and a password format.

It is apparent to those having ordinary skill in the field to which the present invention pertains that various substitutions, modifications and variations can be made without departing from the technical spirit of the present invention.

Accordingly, the present invention is not limited to the embodiments, and the accompanying drawings and the present invention must be interpreted within the scope of the appended claims.

1-6. (canceled)

7. A method of receiving data service in an electronic device, the method comprising:
receiving status information from a first device receiving a data service of a specific contents from a server through short-distance wireless communication;
determining whether or not the data service can be executed in the electronic device; and
transmitting the status information to one of the server and a second device according to the determination result.

8. The method of claim 7, wherein the determining whether or not the data service can be executed is performed based on the received status information.

9. The method of claim 8, wherein the selectively transmitting the status information comprises:
transmitting the status information to the server if the data service can be executed in the electronic device; and
transmitting the status information to the second device if the data service cannot be executed in the electronic device.

10. The method of claim 9, wherein the transmitting the status information to the second device is performed through short-distance wireless communication.

11. The method of claim 9, further comprising continuing the reception of the data service based on the status information, when the status information is transmitted to the server.

12. The method of claim 7, wherein the status information comprises the location of the server, the name of the specific content, authentication information, and a playback position of the specific content.

13. The method of claim 7, wherein the short-distance wireless communication is one among NFC (Near Field Communication), Bluetooth, Zigbee, and Wireless LAN.

14. The method of claim 7, wherein the data service is a streaming service.

15. An electronic device comprising:
wireless communication unit configured to communicate with a server providing a data service of a specific content;
short-distance wireless communication unit configured to perform short-distance wireless communication; and
controller configured to receive status information from a first device receiving a data service of a specific contents from a server through the short-distance wireless communication unit, determine whether or not the data service can be executed in the electronic device, and transmit the status information to one of the server and a second device according to the determination result.

16. The electronic device of claim 15, wherein the controller determines whether or not the data service can be executed in the electronic device based on the received status information.

17. The electronic device of claim 16, wherein the controller transmits the status information to the server if the data service can be executed in the electronic device, or transmits the status information to the second device if the data service cannot be executed in the electronic device.

18. The electronic device of claim 17, wherein the controller transmits the status information to the second device through short-distance wireless communication, when the status information is transmitted to the second device.

19. The electronic device of claim 17, wherein the controller further configured to continue the reception of the data service based on the status information, when the status information is transmitted to the server.

20. The electronic device of claim 15, wherein the status information comprises the location of the server, the name of the specific content, authentication information, and a playback position of the specific content.
